(19) United States
(12) Patent Application Publication
(10) Pub. No.: US 2014/0279011 A1
(43) Pub. Date: Sep. 18, 2014

(54) GENERATING PROMOTIONS FOR A SERVICE USING A MAP INTERFACE

(71) Applicant: Uber Technologies, Inc., San Francisco, CA (US)

(72) Inventors: Brian Richard McMullen, San Francisco, CA (US); Mina Radhakrishnan, San Francisco, CA (US); Ryan McKillen, San Francisco, CA (US); Amos Barreto, San Francisco, CA (US)

(21) Appl. No.: 13/830,224

(22) Filed: Mar. 14, 2013

(51) Int. Cl. G06Q 30/02

(52) U.S. Cl. CPC G06Q 30/0261
USPC 705/14.58

(57) ABSTRACT

A method for generating promotions for a service is provided. One or more processors provide, on a display of a computing device, a user interface to enable a promoter to create a promotion for a service. The user interface provides a plurality of parameters for the promotion. The promoter is enabled to configure at least one of the plurality of parameters for the promotion. A map interface is provided, on the display, to enable the promoter to identify a geographic region in which the promotion can be used by one or more customers. The promoter can identify the geographic region by creating a boundary using three or more location points selected on the map interface.

### BACKGROUND

On-demand services exist in various forms, including transport and location-relevant services. The use of location-aware, mobile computing devices facilitate the use and promotion of such services.

### BRIEF DESCRIPTION OF THE DRAWINGS

FIG. 1 illustrates an example system for enabling the creation and use of promotions for a service.

FIG. 2A illustrates an example method for generating promotions for a service.

FIG. 2B illustrates an example method for implementing promotions for a service.

FIGS. 3A and 3B illustrate example user interfaces for generating promotions for a service.

FIG. 4 is a block diagram that illustrates a computing system upon which examples described herein may be implemented.

FIG. 5 is a block diagram that illustrates a computing device upon which examples described herein may be implemented.

### DETAILED DESCRIPTION

Examples described herein provide for a system and method to generate promotions for a service using a geographic or location-oriented interface. In some examples, a promoter or administrator of the system can interact with one or more user interfaces to configure one or more parameters for a particular promotion. The parameters can define details for the promotion as well as conditions, such as geographic conditions, that must be satisfied in order for a customer to receive the benefits of the promotion.

In one implementation, a promotion system can provide, on a display device, one or more user interfaces to enable a promoter or administrator of the system to create, edit, and/or monitor one or more promotions for a service. A service can include on-demand services, geographically-based (or location-based) services, and/or transport services. Such services can include, for example, a delivery service, a babysitting service, an entertainment service, a moving service, a food service, or a taxi service. In one example, the promoter can create a promotion by interacting with a user interface that provides a plurality of parameters for the promotion. The promotion generation system can provide a map interface to enable the promoter to identify a geographic region in which the promotion can be used by one or more customers. The promoter can identify the geographic region by creating a boundary using three or more location points selected on the map interface.

The geographic region can represent an area in which a request for service can be generated by a customer in order for the customer to use the promotion (e.g., to receive the benefits of the promotion). As an alternative or variation, the geographic region can correspond to an area in which the service can be completed (or substantially completed) by a service provider in order for the customer to use the promotion. In one implementation, multiple geographic regions can be configured for a single promotion. For example, for one particular promotion to be used by a customer, the customer must request for service at a first geographic region and the service must be completed at a second geographic region.

In some examples, the promotion system can be provided in connection with an on-demand service that arranges a service between a customer and a service provider. In some implementations, a promotion can be communicated to one or more customer computing devices to enable individual customers to use the promotion. The promotions can be provided subject to one or more conditions that need to be satisfied for the promotion to be available to a customer.

Still further, a promoter can specify a plurality of parameters for a promotion via one or more user interfaces. The parameters specified by the promoter can include details and/or conditions for the promotion, such as a name of the promotion, an identifier for the promotion, a type of discount, an amount or credit for the promotion, a time constraint for the promotion, a geographic constraint for the promotion, a customer type who can use the promotion, a maximum number of times the promotion can be used by customers, and/or a message that is provided with the promotion. A promotion can be defined in part by the parameters specified by the promoter. Individual promotions, as defined by the parameters specified by individual promoters, can be stored for future use by a population of customers.

As described herein, a “user,” a “requester,” or a “customer” is invariably used to refer to individuals that are requesting or ordering a service. Also as described herein, a “provider,” a “service provider,” a “supplier,” or a “vendor” is invariably used to refer to individuals or entities that can provide the service. A “promoter” or “administrator” is invariably used to refer to individuals or entities that can operate, control, and/or manage a system, such as a promotion system and/or a service system. In addition, as described herein, a customer computing device refers to computing devices, such as desktop computers, cellular or smartphones, laptop computers, tablet devices, television (IP Television), etc., that can provide network connectivity and processing resources for enabling a customer to communicate with a system over a network.

Examples described herein provide that methods, techniques, and actions performed by a computing device are performed programmatically, or as a computer-implemented method. Programmatically, as used herein, means through the use of code or computer-executable instructions. These instructions can be stored in one or more memory resources of a computing device or a wireless access point. A programmatically performed step may or may not be automatic.

One or more examples described herein can be implemented using programmatic modules or components. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices, such as mobile computing devices, access points, desktop computers, cellular or smart phones, laptop computers, servers, or routers. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines or devices shown with examples herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, PCs, televisions) are all examples of machines and devices that utilize processors, memory, and instructions stored on computer-readable mediums. Additionally, some examples may be implemented in the form of computer-programs, or a computer usable carrier medium capable of carrying such a program.

System Description

FIG. 1 illustrates an example system for enabling creation and use of promotions in connection with an on-demand service. A promoter using the system can specify, for a promotion, one or more geographic conditions, time conditions, and/or other conditions or parameters that need to be satisfied for a customer to receive the benefit of the promotion. For example, a promotion can have a parameter specifying a geographic region that a customer must be located at when requesting the on-demand service, or a geographic region that a customer requests the on-demand service to be provided at. In this manner, the system can enable a promoter for the service to better control how and when a customer can receive the benefit of the promotion.

A promotion system, such as system 100 as described in FIG. 1, can be implemented in a variety of computing environments. System 100 (and one or more of its components) can be implemented using memory and processing resources of one or more computing devices. For example, system 100 can be implemented through a combination of servers or other network-enabled computing devices. In other variations, system 100 can be implemented on other computing platforms, including stand-alone systems. As an alternative or addition, some or all of the components of system 100 can be implemented on client devices, such as through applications that operate on user terminals. Accordingly, system 100 can be implemented as a promotion service to enable a promoter or administrator of system 100 to create a promotion for a service by interacting with one or more user interfaces, including a map interface.

In some examples, system 100 can communicate over one or more networks, via one or more network interfaces (e.g., wirelessly or using a wireline), to communicate with one or more customer devices 160. The network may include the Internet, wireless local area networks (WLANs), cellular networks, or other networks for enabling communication between devices. System 100 can also be a part of, be included with, and/or communicate with a service system. As an example, a customer communicate with the service system over a network using a customer device 160 in order to request a service, such as a transportation or delivery service (e.g., food delivery, messenger service, food truck service, or product shipping) or an entertainment service (e.g., mariachi band, string quartet). The service system can then arrange for the service to be performed by a service provider, such as a driver, a food provider, a band, etc. A promotion that is generated by system 100 can be used by the customer when requesting the service to receive a benefit of that promotion.

In one example, system 100 includes a promotion engine 110, a promotion database 130, a promotion notification 140, and a device interface 150. The components of system 100 combine to generate one or more promotions for a service, such as a transport service. In some variations, the components that are described in system 100 can be each provided as individual components or modules, or as part of other components. Logic can be implemented with various applications (e.g., software) and/or with hardware of one or more computing devices that implements system 100.

The promotion engine 110 can provide a variety of different user interface features for creating, managing, and/or editing one or more promotions for a service. In one example, the promotion engine 110 can include a promoter interface 120 that provides an output 113 (e.g., in the form of one or more user interfaces) to a promoter or administrator of system 100. The promoter interface 120 can also receive promoter input 115 (e.g., via one or more user input mechanisms) when the promoter interacts with the displayed user interface(s). In some variations, the promoter engine 110 can include one or more databases (and/or communicate with a database) that stores the variety of user interface features that can be provided to the promoter. The database(s) can also include one or more user interface frameworks that can be used by the promoter interface 120 to generate different user interface features.

In some examples, a promoter can access system 100 through a particular network site that is operated by system 100. Each (or some) of the user interface features can be rendered on a display as a functional web page that runs on a browser of a computing device. In variations, the user interfaces can be provided as part of a client application that runs on a computing device that connects to a site where system 100 is provided. The promoter interface 120 can provide an output 113 (e.g., a particular user interface) based on a received promoter input 115. For example, the promoter interface 120 can provide a promotion manage user interface that displays (e.g., as a table, a list, with graphics, etc.) a plurality of promotions that have been created and stored with a promotion database(s) 130.

In some implementations, the promoter interface 120 can provide the promotion manage user interface by retrieving (or receiving), from the promotion database 130, a promotion ID 117 and its associated parameters 119 for existing or active promotions. The promotion manage user interface can identify a variety of different information for promotions that have been created for the service system. In one example, the promotion manage user interface can present a table of information that specifies, for each promotion that exists (e.g., has already been created), (i) a promotion identifier (ID), (ii) a promotion type, (iii) a promotion category, (iv) a description of the promotion, (v) type of currency, (vi) an amount for the promotion (e.g., as an absolute value or a percentage discount), (vii) a number of times the promotion can be used by the same customer, (viii) time constraints (e.g., the date and/or time the promotion becomes in effect and/or the date and/or time the promotion ends), (ix) customer types who can redeem the promotion, (x) a redemption limit for the promotion (e.g., a maximum number of customers who can use the promotion and/or a counter that shows the current/real-time number of customers who have used the promotion), (xi) geographic constraints, and/or (xii) other information about the promotion.

A promoter can interact with the promotion manage user interface (e.g., by providing promoter input 115) to view details about one or more of the promotions for the service, to modify the one or more promotions, to cancel the one or more promotions, or to create a new promotion. For example, the promoter can select an ID of a particular promotion to view specific details about that promotion. The promoter can view, for example, whether the promotion is currently ongoing (e.g., is in effect), how many customers have redeemed the promotion, whether any changes need to be made to the existing promotion (e.g., raise a discount amount for a service, reduce the number of times a particular customer can use the promotion), etc. The promoter can also make changes to one or more parameters 119 of a promotion and update the promotion so that the changes are stored with the appropriate promotion ID 117 in the promotion database 130. In some variations, the promoter can also search for a specific promotion stored in the promotion database 130 using the promotion manage user interface. The promoter can, for example, input a query for (i) a text string in the description of a promotion, (ii) a promotion ID, (iii) a code for the promotion, and/or (iv) other searchable text strings.

The promoter can also interact with the promotion manage user interface (or another user interface feature) to create a new promotion for a service. For example, the promoter can select a feature (e.g., a “create promotion” or “add new” feature) provided on the promotion manage user interface to view a promotion create user interface. Depending on implementation, the promotion create user interface can be a new page (e.g., a new web page) or a pop-up feature that overlays the promotion manage user interface. By interacting with various features displayed on the promotion create user interface, a promoter can select and/or configure a plurality of parameters for the promotion the customer wishes to create. In examples described, the parameters can include details and/or conditions for the promotion, such as a name of the promotion, an identifier for the promotion, a type of discount, an amount or credit for the promotion, a time constraint for the promotion, a geographic constraint for the promotion, a customer type who can use the promotion, a maximum number of times the promotion can be used by customers, and/or a message that is provided with the promotion.

In one example, the promoter can interact with the promotion create user interface to identify a geographic region in which the promotion can be used by a customer. The geographic region can represent an area in which the service must be requested by a customer in order for the customer to use the promotion (e.g., to receive the benefits of the promotion) or can represent an area in which the service must be completed by a service provider in order for the customer to use the promotion. In another example, the promoter can identify two or more geographic regions, such as a first geographic region that the customer must be located in when requesting the service and a second geographic region that the customer must be located in when the service is completed.

Depending on implementation, the promotion create user interface can provide a plurality of selectable options to set as the geographic region, such as a particular city, county, state, country, etc., or a geofence. A geofence can refer to an area having a border or boundary that is defined using three or more location points (e.g., three or more sets of latitude and longitude coordinates). The geofence can correspond to any type of area, such as a portion of a city, multiple cities, multiple counties, multiple states, etc., that is configured by the promoter using a map interface (or geofence interface). In one example, the map interface can be provided by the promoter interface 120 by using map data 121 that is retrieved or received (e.g., via an application programming interface (API)) from a map database or map source (e.g., from a mapping service). As an addition or an alternative, map data 121 can be stored in and received from a database of the promotion engine 110, system 100, and/or the service system.

Using the map data 121, the promoter interface 120 can provide the map interface so that the promoter can interact with a displayed map to view a particular geographic region (e.g., search a location, pan, zoom in, zoom out). The promoter can create a geofence for a promotion by creating a boundary for the geofence. For example, the promoter can add or mark a first vertex or location on the displayed map, then continue to add two or more vertices or locations (e.g., moving clockwise or counter-clockwise from the first vertex) to identify the boundary of the geofence. In this manner, the map interface can provide a flexible mechanism for a promoter to specify a particular geographic region that is not previously defined by or in a map database (e.g., the promoter can identify a geographic region that is not of a particular region, city, county, state, etc.). For example, the identified geographic region can be defined by an irregular polygon having three, five, or ten, etc., vertices or locations. In other variations, a geofence can be defined by a promoter by selecting and using a set of preconfigured markers that make up a certain polygon or shape, then placing the polygon or shape on the displayed map, and then adjusting one or more of the markers (e.g., individually, or increasing or decreasing the size of the polygon or shape).

In some examples, when the promoter identifies a geographic region for a new promotion, the promoter can select a geofence that has been previously created and stored in a geofence database. For example, a promotion that has already been created and stored in the promotion database 130 can have a geographic region that was previously identified as a geographic constraint. A promoter can interact with a user interface, such as the promotion creation user interface, to search for and use a previously generated geofence for the new promotion that he or she wishes to create. Similarly, a promoter can select to view a previously generated geofence in order to edit one or more markers of the geofence and save as a new geofence for purposes of the new promotion.

Once the promoter has completed configuring the parameters of the new promotion (including identifying one or more geographic regions), the promoter can select a “create” or “finish” feature from the promotion create user interface to create the promotion. In response to receiving the promoter input 115 to create the promotion, the promotion engine 110 generates an ID 117 for the new promotion and records/stores the selected or configured parameters 119 with the associated ID 117 in the promotion database 130.

System 100 can also include a promotion notification 140 to determine when to send information about a promotion to one or more customers, to determine which customers are to receive information about the promotion, and/or to determine how the information about the promotion is to be provided to one or more customers. The promotion notification 140 can generate a message 143 that includes information about a particular promotion 141. The promotion notification 140 can determine when to send information about the promotion 141 to one or more customers (i) in response to a new promotion 141 being created by the promotion engine 110, and/or (ii) based on a schedule configured by system 100 or the service system.

For example, the promotion notification 140 can be instructed by the service system to monitor the promotion database 130 on a set schedule (e.g., monitor the promotion database 130 every day, every two days, etc.). The promotion notification 140 can then identify, for one or more promotions, the start time for that promotion (e.g., a date and/or time in which that promotion can be used by a customer). The promotion notification 140 can then send information about a promotion 141 a specific time period before that promotion is to be active (e.g., generate a message 143 for the promotion one day before, one week before, one month before, etc.). The specific time period can be configured by a promoter or an administrator of system 100 and/or the service system.

The promotion notification 140 can also use information provided with a promotion 141 (including parameters specified for that promotion 141) to determine which customers are to receive information about the promotion and how the information is to be provided (e.g., via a text message, such as a Short Message Service (SMS) message, an email message, and/or a message provided to an application running on a customer device that communicates with the service system). For example, a promotion 141 can specify an individual customer, or a class or group of customers that can receive the promotion 141 (e.g., new customers, customers who have requested and received service a certain number of times, customers who have a billing address, home address, or are currently located in a particular geographic region, such as a city, state, or geofence, etc.). Similarly, the promotion 141 can specify how the information about the promotion is to be sent to the specified customer(s).

When a message 143 about a promotion 141 is to be sent to a specified customer(s), the promotion notification 140 can provide the message 143 to a device interface 150. The device interface 150 can be used to handle communications to one or more customer computing devices 160. In one example, the device interface 150 can enable system 100 and/or the service system to transmit and receive communications from one or more customer computing devices 160. The device interface 150 can receive the message 143, determine which customer device(s) 160 to send a promotion message 151 to, and transmit the promotion message 151 over one or more networks to the respective customer device(s) 160 using a medium or protocol specified for that promotion (e.g., via a text message, an email message, and/or a message provided to an application running on a customer device that communicates with the service system).

Depending on implementation, the promotion message 151 can include a variety of information, such as a description of the promotion for a service, instructions on how to use the promotion, an amount or percentage off (or credit) the promotion provides for the service, specifics and conditions for when the promotion can be used by a customer, a promotion code, and/or one or more images or graphics.

In some variations, one or more components of system 100 can be a part of, be included with, and/or communicate with the service system (e.g., a system that arranges service between requesters and service providers). For example, the promotion notification 140 and/or the device interface 150 can be a part of the service system. The service system can communicate with the promotion notification 140 and/or the device interface 150 to determine when system 100 is to provide a promotion message 151 to one or more customer devices 160 and what information is provided as part of the promotion message 151.

A customer operating a customer device 160 can use or apply a promotion when requesting a service. For example, a customer can operate an application that communicates with a service system. Using the application, the customer can make a request for a service, and can enter a code for the promotion that provides a benefit to the customer if conditions for the promotion are satisfied. The service system can access the promotion database 130 in order to look up the code entered by the customer and determine whether the customer is allowed to receive the benefit of the promotion. For example, the service system can look up the code, determine that the code matches a promotion ID, and identify one or more parameters for that promotion. If the customer's request satisfies various conditions, such as time constraints (e.g., the customer is using the promotion during a period of time that the promotion is valid) and/or geographic constraints (e.g., the customer is requesting the service within a starting geographic region or geofence specified for that promotion or is requesting the service to be completed at a destination region or geofence), the service system can enable the customer to receive the benefit of the promotion. In one example, the service system can automatically discount or provide a credit to the customer or to the customer's account when the service is completed by a service provider.

As an addition or an alternative, a service entity that operates system 100 and/or the service system can have standing agreements with third party entities (e.g., an individual or company that provides services or products, such as an airline or a device manufacturer, etc.) so that the third party entities can market the services of the service entity to their customers (e.g., to their frequent fliers in the example of an airline). For example, a link can be provided on a web site of the airline so that their frequent fliers can receive a promotion if they choose to use the service provided by the service entity (e.g., use a transport service). The airline can generate and provide a specific code (that is not yet created or associated with a promotion stored in the promotion database 130) for the service. When a frequent flier selects the link and requests service, the promotion engine 110 can receive the third party specified code (e.g., from the service system or from the third party network resource), identify a promotion for that third party (based on the standing agreements) from the promotion database 130, and associate the third party specified code to the promotion. In this manner, system 100 enables codes to be created by third party entities, and can associate multiple codes to existing promotions.

Methodology

FIG. 2A illustrates an example method for generating promotions for a service. A method such as described by FIG. 2A can be implemented using, for example, a system and components such as described with FIG. 1. Accordingly, references made to elements of FIG. 1 are for purposes of illustrating a suitable element or component for performing a step or sub-step being described.

A user interface is provided, e.g., by the promotion engine 110, to enable a promoter or administrator to create a promotion for a service (210). The user interface can provide a plurality of parameters that can be specified for the promotion. For example, the promoter can operate system 100 using a computing device (e.g., a laptop computer) to create a promotion (e.g., 25% off total cost) for a transport service for Valentine's Day. In one implementation, the user interface can be provided as part of a functional web page that runs on a browser of the computing device.

The promoter is enabled to configure one or more parameters for the promotion by interacting with the user interface (220). For example, the user can specify by providing user input, a type of promotion (e.g., a discount for the transport service), the amount (e.g., 25% off), time constraints (e.g., promotion starts at 12:01 am on Feb. 14, 2013 and ends 11:59 pm on Feb. 14, 2013), a character string for the code that a customer must input (e.g., “LOVE DISCOUNT”), how many times a particular customer can use the promotion (e.g., single use, five times maximum), and/or which customer or customers can use the promotion. The promoter can also configure a geographic constraint for the promotion by interacting with the user interface.

Depending on variations, a promoter can configure a geographic constraint having a geographic region in which the service must be requested by a customer in order for the customer to use the promotion (e.g., to receive the benefits of the promotion) or having a geographic region in which the service must be completed by a service provider in order for the customer to use the promotion. In another example, multiple geographic regions can be configured for a single promotion using the user interface. The promoter can select a particular city, county, state, etc., using the user interface to configure the geographic constraints. In some cases, however, the promoter can identify a geographic region using a map interface.

The promotion engine 110 can provide a map interface to enable the promoter to identify one or more geographic regions for the promotion in which the promotion can be used by one or more customers (230). The map interface can be provided to enable the promoter to specify any type of geographic region (e.g., a region that is not predefined as a particular city, county, state, country, etc.) for the promotion. In one example, the map interface can provide a map that the promoter can interact with. The promoter can create a boundary for the geographic region (e.g., create a geofence) by selecting three or more vertices or location points on the map that define the geographic region. Depending on implementation, the map interface can be provided concurrently with the user interface provided in step 210.

Once the promoter has completed configuring the parameters for the promotion, the promotion engine 110 can generate the promotion with the specified parameters and identified geographic constraints (240). The promotion engine 110 can create a promotion ID, associate the parameters with the promotion ID, and store the promotion in a promotion database. The promotion information for the promotion can be transmitted to one or more customers so that the one or more customers can be enabled to use or apply the promotion when requesting a service (250).

In some examples, the promotion information can be sent to one or more customer devices by providing a corresponding code (e.g., “LOVE DISCOUNT”) via a text message, an email message, and/or a message provided to an application running on a customer device that communicates with the service system.

A customer can use the promotion in a variety of different ways (260). A customer can operate an application that communicates with the service system, for example, to type in or provide the code that the customer has received in order to use the promotion. In another example, the customer can send a request for a service by texting a message (such as an SMS) using a phone number provided by the service system. The message can include the promotion code and the service system can apply the promotion to the customer's account automatically once the message with the promotion code is received. The customer can also access a web site corresponding to the service system, and apply the promotion code to his or her account.

For example, when the customer uses the application to request a service and enters a code for the promotion that, the service system can access the promotion database in order to look up the code entered by the customer and determine whether the customer is allowed to receive the benefit of the promotion based on the geographic region or geofence. If the customer's request satisfies various conditions, such as time constraints (e.g., the customer is using the promotion during a period of time that the promotion is valid) and/or geographic constraints (e.g., the customer is requesting the service within a starting geographic region or geofence specified for that promotion or is requesting the service to be completed at a destination region or geofence), the service system can enable the customer to receive the benefit of the promotion.

FIG. 2B illustrates an example method for implementing promotions for a service. A method such as described by FIG. 2B can be implemented using, for example, a system and components such as described with FIG. 1. Accordingly, references made to elements of FIG. 1 are for purposes of illustrating a suitable element or component for performing a step or sub-step being described.

A service system for location on-demand services, such as a transport service system or a delivery service system, can determine that a customer has provided a promotion code for a promotion (265). In some examples, the service system can receive one or more communications from a computing device associated with a customer that the customer has input a particular character string for the promotion (e.g., via an application running on the computing device, or in response to the customer accessing and inputting a code via a web site corresponding to the service system).

The service system can receive a request for a location on-demand service, such as a transport service, that indicates to the service system a pick-up or start location and/or a drop off or delivery location (270). The request can identify the current location of the customer (e.g., the current location of the customer's computing device) and/or a designated start location that is provided by the customer. In response to receiving the request, the service system can determine one or more conditions that must be satisfied by the customer and/or the request in order for the customer to receive the benefit of the promotion (275).

The conditions can correspond to conditions and/or parameters described with respect to FIGS. 1 and 2A. For example, the conditions can include one or more geographic conditions (e.g., based on geofences identified by the promotion corresponding to the inputted promotion code) (276), time conditions (277), and/or other conditions, such as customer types (278), that must be satisfied in order for the customer to receive the benefit. The service system can identify or determine the conditions by performing a search or looking up a promotion corresponding to the inputted promotion code in a promotions database (such as the promotion database 130 of FIG. 1).

The service system can then determine whether the request for the service satisfies the necessary conditions (280). If the conditions are satisfied, e.g., the request satisfying the geofence(s) or geographic condition(s) of the promotion and/or the time condition(s), the benefit of the promotion is applied to the customer's account (285). On the other hand, if the request does not satisfy the condition(s) specified by the promotion, the benefit of the promotion is not applied to the customer's account (290). In this manner, a promotion can be applied or implemented based on whether the geographic conditions of the promotion have been satisfied.

Example User Interfaces

FIGS. 3A and 3B illustrate example user interfaces for generating promotions for a service. In some examples, the user interfaces described in FIGS. 3A and 3B can be provided (and displayed on a display of a computing device) by a system and components such as described with FIG. 1. The example described with FIGS. 3A and 3B are directed to promotions for a transport service system, but FIGS. 3A and 3B can also illustrate user interfaces provided by a promotion system for other types of services. FIG. 3A illustrates a promotion creation user interface as described in FIG. 1.

The promotion creation user interface 300 can include a plurality of parameters that can be configured by a promoter. The promotion creation user interface 300 can be provided to enable the promoter to create a new promotion for a service, such as a transport service, or to modify an existing promotion. In one example, the parameters can be grouped into different types or categories of parameters. For example, as illustrated in FIG. 3A, the promotion creation user interface 300 can include parameters related to type 310, parameters related to geography 315, descriptions for the promotion 320, parameters related to cost 325, parameters related to timing 330, an activation message for the promotion 335, and/or other details for the promotion 340.

A promoter can interact with the promotion creation user interface 300 to configure the type of promotion, such as a discount for the service (e.g., 10% off) or an account credit (e.g., user gets $20 USD to spend on the service). Other types (that are not illustrated in FIG. 3A) can include free products or items, a free service for a certain amount of money spent or for a certain number of times the service is requested, a special vehicle for a transport service (e.g., a limousine), etc. The promoter can also select a category for the new promotion that is being created. Categories can include a promotion for an event, a promotion for new users, a promotion for valued customers or users, other categories, etc. These parameters that are related to type 310 can help identify, for example, what the new promotion is to be used for when providing the promotion to one or more customers.

The parameters related to geography 315 identify a geographic region in which the promotion can be used by one or more customers. These parameters can identify a condition that must be met in order for the customer(s) to receive the benefit of the promotion. For example, the promoter can select a particular city, country, county (not shown), state (not shown), etc., in which the service must be requested by a customer in order for the customer to use the promotion (e.g., to receive the benefits of the promotion), in which the service must be completed by a service provider in order for the customer to use the promotion, and/or both. In some examples, based on the user's selection of the selectable options for the geographic region, different drop down menus can be provided (e.g., for “city,” the drop down menus will display city names and corresponding currency types for the cities, for “country,” the drop down menus will display country names and corresponding currency for the countries). Although not shown in the example of FIG. 3A, the promoter can select one geographic region as a “start” region, and/or another geographic region as an “end” region.

The promoter can also select the “Geofence” feature, so that the drop down menu provides a list of geofences that have previously been created and stored, as well as a selectable feature (e.g., “create new” geofence feature) to enable the promoter to create a new geofence for the promotion. Selection of the “create” new geofence feature can cause a map user interface to be displayed to the promoter. For example, FIG. 3B illustrates a map user interface as described in FIG. 1. Depending on implementation, the map user interface 360 can be provided as a new user interface or as a pop-up feature that overlays the promotion creation user interface 300.

The map user interface 360 can include a map 370 to display a particular geographic region. The promoter can interact with the map 370 (e.g., search a location, pan, zoom in, zoom out) in order to view a particular region in which the promoter would like to create a geofence. The promoter can create a boundary 375 for the geofence by adding a plurality of location markers 377 (e.g., three or more) on the displayed map 370. In this manner, the promoter can specify a very small geographic region, a very large geographic region, and/or an oddly shaped geographic region for the new promotion.

The map user interface 360 also includes a title text box 380 for inputting a title for the geofence and/or a description title box 385 for describing the geofence. The title and/or description can help the promoter and/or other promoters to identify existing promotion geofences for future use. For example, the promoter can create another promotion at a later time and use the geofence titled “san_francisco” without having to create a new geofence. The map user interface 360 can also include other selectable features (not shown in FIG. 3B), such as a “create” or “add” feature for indicating that the promoter has finished configuring the geofence, “remove” or “delete” feature for deleting the current geofence, “save” feature for saving the current state of the geofence if the geofence is a previously created geofence that is being edited, and/or a “revert” feature for reverting back to the previously saved state of the geofence if the geofence is a previously created geofence that is being edited. Once the promoter has completed creating or editing the geofence, the map user interface 360 can be dismissed from the display and the promotion creation user interface 300 can be displayed to enable the promoter to continue to configure other parameters of the promotion.

Referring back to FIG. 3A, the promotion creation user interface 300 also includes other details that can be configured by the promoter, such as a description for the promotion 320, and parameters related to cost 325. In some examples, one or more descriptors (e.g., “Trip city:” or “How much USD off?”) can be dynamically altered based on selected parameters by the promoter. For example, depending on the city or country selected, and/or whether the promoter selected “set amount” or “% of fare,” the descriptor for how much amount discount can display different text (e.g., display “How much Euro off?” instead of “How much USD off?”). In addition, if the promoter selected a set amount, the promoter can input a set amount of dollars the promotion provides a discount for, as opposed to a percentage.

The promoter can also interact with the promotion creation user interface 300 to configure parameters related to timing 330 and provide an activation message for the promotion 335. The parameters related to timing 330 can provide one or more timing conditions that must be satisfied for a customer to use the promotion. For example, the promotion can be valid for a service that is requested on or after a particular date and time, and/or is requested before a particular date and time. The promoter can then configure the promotion to last a particular duration of time (e.g., hours, days, weeks, etc.). The promoter can also configure a custom user activation message to provide a message to the customer. For example, the activation message can be displayed to the customer (e.g., once the user activates the promotion by entering the promotion code) congratulating the customer for getting a discount for the service and/or thanking the customer for his or her loyalty.

The promotion creation user interface 300 can also enable the promoter to configure other details for the promotion. The promoter can specify a number of times the promotion can be used by a customer (e.g., the customer can only use the promotional code once or twice), and specify what type of customers are to receive the promotion (e.g., new users or users who have used the service a predetermined number of times or users who live in a particular area, etc.). In some examples, the promoter can also specify how many promotion codes (e.g., a code is a character string that a customer must input) are to be created for the new promotion (e.g., four codes for a single promotion), as well as the code the customer is to enter. The promotion creation user interface 300 can enable the promoter to configure provide a redemption limit, or a maximum number of customers who can enter each code, and choose whether the discount of the promotion is to be automatically applied to the accounts of selected customers or customer types without having the customer(s) enter the code. In some examples, a promoter can interact with the various user interface features to provide promotion codes that can be scanned using a reader device, to copy promotion codes, or to create a promotion having a batch of random promotion codes (e.g., create 50 of the same kind of promotion).

In this manner, a promotion system, such as system 100 of FIG. 1, can provide a promoter with a full range of options when creating a new promotion for any type of service. A promoter can interact with the user interface features provided to configure a plurality of parameters to create a promotion for a specific event (e.g., a particular concert, governmental meeting, sporting event, etc.) or for repeated dates (e.g., Holidays, last day of every month). The promoter can also create promotions for particular users or types/groups of users.

Examples of promotion that can be created using a promotion system can include, but are not limited to, the following: (i) counter-based promotions (e.g., buy three, get one free), (ii) weekly promotions (e.g., half off on Mondays), (iii) time of day promotions (e.g., half off before 6 AM), (iv) new customer vs. existing customers, (v) multiple geofences, (vi) flat rate promotion (e.g., $10 for rides on Tuesdays), (vii) geofence flat rate (e.g., $20 flat rate for rides from a first geofence to another), or (viii) loyalty promotions (e.g., get every 5^{th} ride free).

Hardware Diagram

FIG. 4 is a block diagram that illustrates a computing system upon which examples described herein may be implemented. For example, in the context of FIG. 1, system 100 may be implemented using a computer system (or a combination of computer systems) such as described by FIG. 4.

In one implementation, computer system 400 includes processor 410, main memory 420, ROM 430, storage device 440, and communication interface 450. Computer system 400 includes at least one processor 410 for processing information. Computer system 400 also includes a main memory 420, such as a random access memory (RAM) or other dynamic storage device, for storing information and instructions to be executed by the processor 410. Main memory 420 also may be used for storing temporary variables or other intermediate information during execution of instructions to be executed by processor 410. Computer system 400 may also include a read only memory (ROM) 430 or other static storage device for storing static information and instructions for processor 410. A storage device 440, such as a magnetic disk or optical disk, is provided for storing information and instructions.

The communication interface 450 may enable the computer system 400 to communicate with one or more networks 480 through use of the network link (wireless or wireline). Using the network link, computer system 400 can communicate with other computer systems (e.g., such as one or more computer systems that operate and provide a service system) and one or more customer devices, such as a mobile computing device. For example, the computer system 400 can provide one or more promotional messages to at least one of the one or more customer devices (such as described with FIGS. 1 and 2) over the one or more networks 480.

Computer system 400 can include a display device 460, such as a cathode ray tube (CRT), a LCD monitor, or a television set, for example, for displaying graphics and information to a user. An input mechanism 470, such as a keyboard that includes alphanumeric keys and other keys, can be coupled to computer system 400 for communicating information and command selections to processor 410. Other non-limiting, illustrative examples of input mechanisms 470 include a mouse, a trackball, touch-sensitive screen, or cursor direction keys for communicating direction information and command selections to processor 410 and for controlling cursor movement on display 460. While only one input mechanism 470 is depicted in FIG. 4, different variations may include any number of input mechanisms 470 coupled to computer system 400.

Examples described herein are related to the use of computer system 400 for implementing the techniques described herein. According to one example, those techniques are performed by computer system 400 in response to processor 410 executing one or more sequences of one or more instructions contained in main memory 420. Such instructions may be read into main memory 420 from another machine-readable medium, such as storage device 440. Execution of the sequences of instructions contained in main memory 420 causes processor 410 to perform the process steps described herein. For example, processor 410 can execute instructions to provide a promotional user interface(s) 462 on the display device 460. A promoter or administrator of computer system 400 can interact with the promotional user interface(s) 462 to provide one or more promotional configurations 472 (e.g., using one or more input mechanisms 470) when generating a promotion for a service. In one implementation, the promoter can provide promotional configurations 472 by identifying a geographic region in which the promotion can be used by a customer (e.g., by creating a boundary on a map interface 462). In alternative examples, hard-wired circuitry may be used in place of or in combination with software instructions to implement examples described herein. Thus, examples described are not limited to any specific combination of hardware circuitry and software.

FIG. 5 is a block diagram that illustrates a computing device upon which examples described herein may be implemented. According to some implementations, the computing device 500 can correspond to a mobile computing device or tablet device, such as a cellular device that is capable of telephony, messaging, and data services, or other network enabled devices. The computing device 500 includes a processor 510, memory resources 520, a display device 530 (such as a touch-sensitive display), one or more communication sub-systems 540, and input mechanism(s) 550. The communication sub-systems 540 can include network ports, such as wireline or wireless (e.g., cellular, Wi-Fi, etc.) communication ports for communicating with other devices.

The computing device 500 may operate an operating system to enable use of the various components of the device. Additionally, the computing device 500 can implement application level logic and programming. The memory 520 stores instructions for execution by processor 510. In one implementation, the processor 510 can run one or more applications using instructions stored in memory 520. With reference to examples described in FIGS. 1 and 2, the processor 510 can operate an application (e.g., a messaging application, an e-mail application, a browser, an application that communicates with the promotion system and/or the service system) to view a promotional message 542 that is received via the communication sub-systems 540. In some examples, the promotional message 542 can be transmitted by the promotion system and/or the service system over the network 480. A customer operating the computing device 500 can operate an application to provide a service request 544 (e.g., that can include a code for using the promotion corresponding to the received promotional message 542) to the promotional system and/or the service system over the one or more networks 480. Accordingly, the computing device 500 can be configured with software and/or other logic to perform one or more processes, steps and other functions provided with examples, such as described by FIGS. 1 through 3B, as well as elsewhere in this document.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. Accordingly, it is contemplated that a particular feature described either individually or as part of an example can be combined with other individually described features, or parts of other examples, even if the other features and examples make no mentioned of the particular feature.

What is being claimed is:

1. A method for generating promotions for a service, the method being performed by one or more processors and comprising:
providing, on a display of a computing device, a user interface to enable a promoter to create a promotion for a service, the user interface providing a plurality of parameters for the promotion;
enabling the promoter to configure at least one of the plurality of parameters for the promotion; and
providing, on the display, a map interface to enable the promoter to identify a geographic region in which the promotion can be used by one or more customers, wherein the promoter identifies the geographic region by creating a boundary using three or more location points selected on the map interface.

2. The method of claim 1, wherein the plurality of parameters includes at least one of a discount type for the promotion, an amount or credit for the promotion, a time constraint for the promotion, a customer type for using the promotion, a maximum number of times the promotion can be used by one or more customers, or a message for the promotion.

3. The method of claim 1, wherein the geographic region in which the promotion can be used specifies an area in which the service must be completed for the one or more customers in order for the promotion to be used.

4. The method of claim 1, wherein the geographic region in which the promotion can be used specifies an area in which the service is requested for by the one or more customers in order for the promotion to be used.

5. The method of claim 1, wherein enabling a promoter to configure at least one of the plurality of parameters includes receiving a user input corresponding to a character string that identifies a code that the one or more customers can input in order to use the promotion.

6. The method of claim 1, further comprising:
generating the promotion having the at least one configured parameter; and
providing a promotional message corresponding to the promotion to one or more corresponding customer computing devices at a predetermined time before the promotion can be used by the one or more customers.

7. The method of claim 6, further comprising:
enabling the one or more customers to use the promotion.

8. A system comprising:
a display;
one or more memory resources; and
one or more processors coupled to the display and the one or more memory resources, the one or more processors to:
provide, on the display, a user interface to enable a promoter to create a promotion for a service, the user interface providing a plurality of parameters for the promotion;
enable the promoter to configure at least one of the plurality of parameters for the promotion;
provide, on the display, a map interface to enable the promoter to identify a geographic region in which the promotion can be used by one or more customers, wherein the promoter identifies the geographic region by creating a boundary using three or more location points selected on the map interface.

9. The system of claim 8, wherein the plurality of parameters includes at least one of a discount type for the promotion, an amount or credit for the promotion, a time constraint for the promotion, a customer type for using the promotion, a maximum number of times the promotion can be used by one or more customers, or a message for the promotion.

10. The system of claim 8, wherein the geographic region in which the promotion can be used specifies an area in which the service must be performed for the one or more customers in order for the promotion to be used.

11. The system of claim 8, wherein the geographic region in which the promotion can be used specifies an area in which the service is requested for by the one or more customers in order for the promotion to be used.

12. The system of claim 8, wherein the one or more processors enable a promoter to configure at least one of the plurality of parameters by receiving a user input corresponding to a character string that identifies a code that the one or more customers can input in order to use the promotion.

13. The system of claim 8, wherein the one or more processors further:
generates the promotion having the at least one configured parameter; and
provides a promotional message corresponding to the promotion to one or more corresponding customer computing devices at a predetermined time before the promotion can be used by the one or more customers.

14. The system of claim 13, wherein the one or more processors further:
enables the one or more customers to use the promotion.

15. A method for implementing one or more promotions for a transport service, the method being performed by one or more processors and comprising:
determining that a customer for the transport service has provided an input code for a promotion;
receiving a request for the transport service from a computing device of the customer, the request including at least a current location of the computing device or a starting location for the transport service;
in response to receiving the request, (i) determining one or more geographic conditions associated with the promotion that must be satisfied for the customer to receive a benefit of the promotion, and (ii) determining that the request satisfies the one or more geographic conditions; and
applying the benefit of the promotion to an account associated with the customer.

16. The method of claim 15, wherein determining that the customer has provided the input code for the promotion includes receiving, from an application running on the computing device of the customer, a communication that includes the input code.

17. The method of claim 15, wherein determining the one or more geographic conditions associated with the promotion includes performing a lookup in a promotions database using the input code.

18. The method of claim 15, further comprising:
in response to receiving the request, determining one or more time conditions associated with the promotion that must be satisfied for the customer to receive the benefit of the promotion.

19. The method of claim 18, further comprising:
in response to receiving the request, determining that the request satisfies the one or more time conditions.

20. The method of claim 15, wherein applying the benefit of the promotion to the account associated with the customer includes providing a discount for the transport service based on a credit amount or a percentage amount.
